(19) United States
(12) Patent Application Publication
(10) Pub. No.: US 2020/0126059 A1
(43) Pub. Date: Apr. 23, 2020

(54) SYSTEMS AND METHODS FOR CONDUCTING ACCOUNTLESS TRANSACTIONS

(71) Applicant: JPMORGAN CHASE BANK, N.A., New York, NY (US)

(72) Inventors: Amro KUDSSI, Westmont, IL (US); Tracy L. DANGOTT, Chicago, IL (US)

(21) Appl. No.: 16/593,465

(22) Filed: Oct. 4, 2019

Related U.S. Application Data
(60) Provisional application No. 62/748,094, filed on Oct. 19, 2018.

(51) Int. Cl. G06Q 20/32; G06Q 20/38; G06Q 20/42

(52) U.S. Cl. CPC G06Q 20/3223; G06Q 20/3821; G06Q 20/3278; G06Q 20/42; G06Q 20/385

(57) ABSTRACT

Systems and methods for conducting accountless transactions are disclosed. In one embodiment, in an information processing apparatus comprising at least one computer processor, a method for conducting accountless transactions may include: (1) receiving, from a payor, a payee unique identifier and a payment instruction comprising a payment amount; (2) associating the payment instruction with the payee unique identifier; (3) receiving, from a mobile payment application executed by a mobile electronic device, a payment device identifier for a payment device and the payee unique identifier; (4) retrieving the payment instruction associated with the payee unique identifier; (5) identifying the payment device based on the payment device identifier; and (6) instructing the identified payment device to dispense at least some of the payment amount.

### RELATED APPLICATIONS

This application claims the benefit of U.S. Provisional Patent Application Ser. No. 62/748,094, filed Oct. 19, 2018, the disclosure of which is hereby incorporated by reference in its entirety

### BACKGROUND OF THE INVENTION

### 1. Field of the Invention

Embodiments are generally directed to systems and methods for conducting accountless transactions.

### 2. Description of the Related Art

Individuals that do not have bank accounts, or do not have an account at a particular financial institution, have difficulty receiving electronic payments from third parties, particularly at ATMs. Even though the individual may have received funds digitally by a payment application, the only way of accessing those funds is by having the funds transferred to a debit card or prepaid, to a bank account, to a digital wallet or by having a check for the amount sent.

### SUMMARY OF THE INVENTION

Systems and methods for conducting accountless transactions are disclosed. In one embodiment, in an information processing apparatus comprising at least one computer processor, a method for conducting accountless transactions may include: (1) receiving, from a payor, a payee unique identifier and a payment instruction comprising a payment amount; (2) associating the payment instruction with the payee unique identifier; (3) receiving, from a mobile payment application executed by a mobile electronic device, a payment device identifier for a payment device and the payee unique identifier; (4) retrieving the payment instruction associated with the payee unique identifier; (5) identifying the payment device based on the payment device identifier; and (6) instructing the identified payment device to dispense at least some of the payment amount.

In one embodiment, the payee unique identifier may be provided by the mobile payment application.

In one embodiment, the method may further include notifying the payee of a plurality of payment devices for receiving the payment.

In one embodiment, the payment device may be an ATM, a kiosk, a point of sale terminal, etc.

In one embodiment, the payment device identifier may include a machine-readable code or a secure token that may be used to initiate a NFC transmission.

In one embodiment, the information processing apparatus may be provided by a financial institution with which the payor has an account.

In one embodiment, the information processing apparatus may be provided by a third party, and the method may further include and further include receiving the payment amount from the payor, and providing the payment amount to an owner of the identified payment device.

According to another embodiment, in an information processing apparatus comprising at least one computer processor, a method for conducting accountless transactions may include: (1) receiving, from a payor, a payee unique identifier and a payment instruction comprising a payment amount; (2) generating a one-time code for the payee; (3) associating the one-time code with the payment instruction; (4) providing a payment message to the payee comprising the one-time code; (5) receiving, from a payment device, a payment request comprising the one-time code; and (6) instructing the payment device to dispense at least some of the payment amount.

In one embodiment, the payee unique identifier may include a payee phone number or a payee email address, and the payment message may be communicated to the payee phone number or the payee email address.

In one embodiment, the method may further include routing the payment request to a financial institution associated with the payee; and receiving approval for the payment request from the payee's financial institution.

In one embodiment, the payment device may be an ATM, a kiosk, a point of sale terminal etc.

In one embodiment, the one-time code may be a machine-readable code or a secure token that may be used to initiate a NFC transmission.

In one embodiment, the one-time code may be a 16-digit code.

In one embodiment, the information processing apparatus may be provided by a financial institution with which the payor has an account.

In one embodiment, the information processing apparatus may be provided by a third party, and the method may further include receiving the payment amount from the payor, and providing the payment amount to an owner of the identified payment device.

According to another embodiment, in an information processing apparatus comprising at least one computer processor, a method for conducting accountless transactions may include: (1) receiving, from a payor, a one-time payment code and a payment instruction comprising a payment amount; (2) receiving, from a payment device, a payment request comprising the one-time payment code; (3) retrieving the payment instruction associated with the one-time payment code; and (4) communicating authorization of the payment request to the payment device, whereby the payment device dispenses at least some of the payment amount.

In one embodiment, the method may further include settling the payment amount with a provider of the payment device.

In one embodiment, the one-time code payment may be a 16-digit code.

In one embodiment, the one-time payment code may be communicated to a payment application executed by a payee mobile electronic device, and the payee mobile electronic device may provide the one-time payment code to the payment device.

In one embodiment, the payment device may be an ATM, a kiosk, a point of sale terminal, etc.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for conducting accountless transactions according to one embodiment;

FIG. 2 depicts a method for conducting accountless transactions according to one embodiment;

FIG. 3 depicts a method of a method for conducting accountless transactions using a third party is disclosed according to one embodiment;

FIG. 4 depicts a method of a method for conducting accountless transactions according to another embodiment;

FIG. 5 depicts a method of a method for conducting accountless transactions according to another embodiment;

FIG. 6 depicts a method of a method for conducting accountless transactions according to another embodiment.

### DETAILED DESCRIPTION OF PREFERRED EMBODIMENTS

Embodiments are directed to systems and methods for conducting accountless transactions.

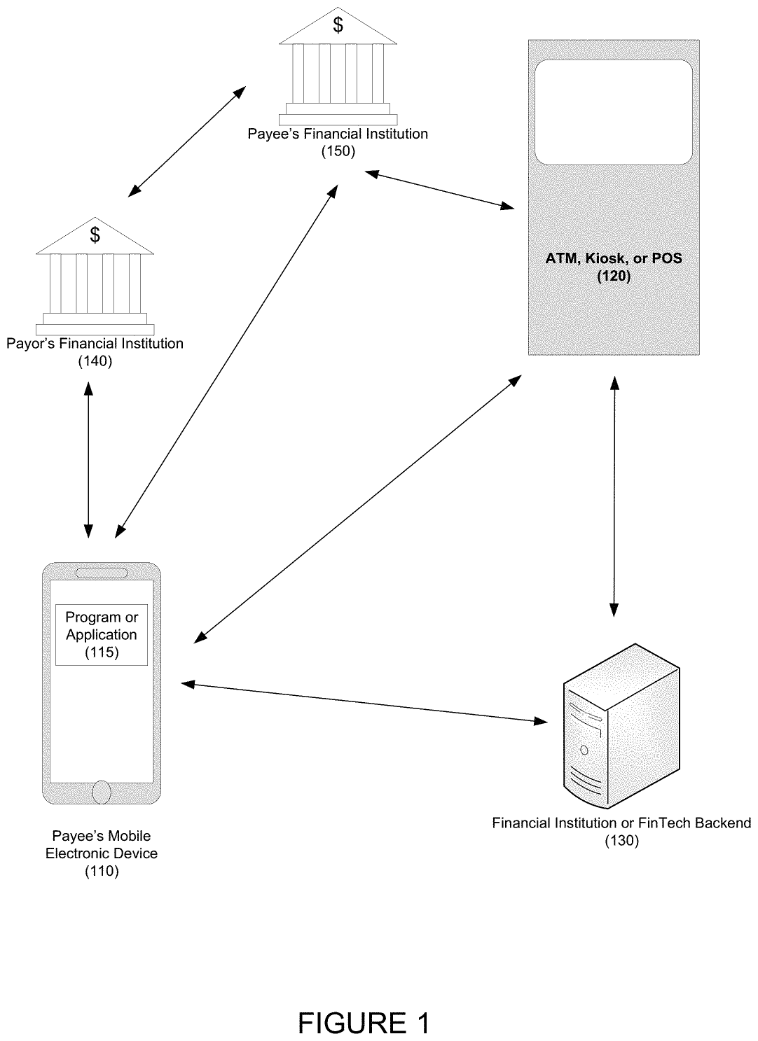

Referring to FIG. 1, a system for conducting accountless transactions is disclosed according to one embodiment. System 100 may include the payee's mobile electronic device 110, payment device (e.g., ATM, kiosk, or point of sale terminal) 120, and financial institution or Financial Technology (FinTech) service provider backend 130. System 100 may further include the payor's financial institution 130 and the payee's financial institution 145.

In one embodiment, mobile electronic device 110 may be any suitable electronic device, including smart phones, tablet computers, notebook computers, smart watches, Internet of Things (IoT) appliances, etc.

Mobile electronic device 110 may execute one or more computer programs or applications 115. For example, mobile electronic device 110 may execute a payment application computer program or application 115. In one embodiment, payment application computer program or application 115 may be an application associated with financial institution or FinTech backend 130, payor's financial institution 140, or payee's financial institution 150.

In one embodiment, mobile electronic device 110, payment device 120, and backend 130 may communicate using any suitable communication method, including the Internet, WiFi, NFC, etc.

In one embodiment, payment device 120 may be associated with a unique identifier, and may present the unique identifier as a machine-readable code (e.g., barcode, QR code, NFC code, etc.). In one embodiment, the machine-readable code may be displayed on a display of payment device 120. In another embodiment, the machine-readable code may be affixed to an exterior of payment device 120.

In one embodiment, payment device 120 and backend 130 may be part of the same network, such as the same financial institution network.

In one embodiment, the payee need not have any prior relationship established with any financial institution or FinTech service to utilize the service.

In one embodiment, backend 130 may be associated with a financial institution (e.g., payor's financial institution 130, the payee's financial institution 145, or a third party financial institution (not shown)), a third party, such as a FinTech, etc. In one embodiment, backend 130 may communicate with payment authorization networks, such as VisaNet.

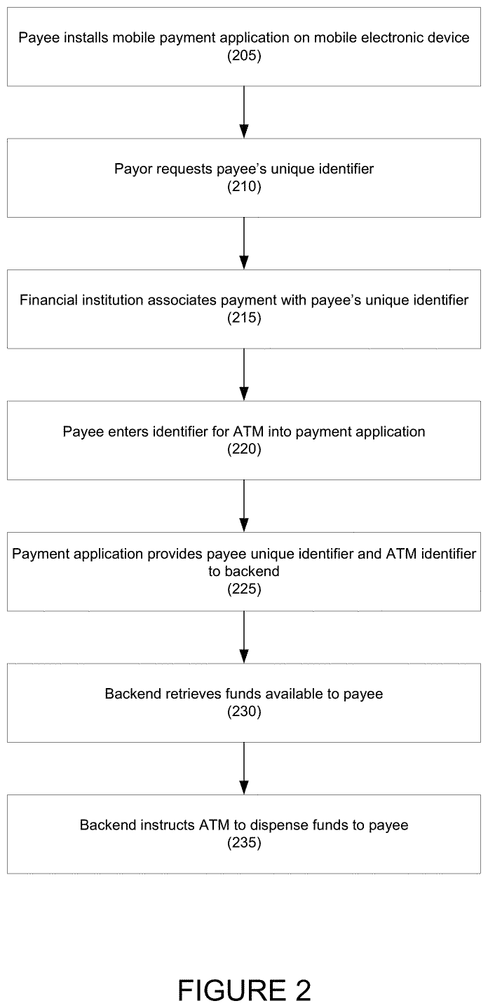

Referring to FIG. 2, a method for conducting accountless transactions is disclosed according to one embodiment.

In step 205, a payee may install a mobile payment application provided by the payor's financial institution on a mobile electronic device. The mobile payment application may generate a unique identifier for the payee as a machine-readable code (e.g., a bar code such as a QR code, a NFC code, an alphanumeric string, etc.). The unique identifier may also be the payee's mobile phone number, email address, etc. In one embodiment, the unique identifier may be selected by the payee and may be verified to be unique.

In one embodiment, the unique identified may also be a one-time use number that mimics the format and length of a network card number, without a physical card having been issued.

In step 210, a payor may request the payee's unique identifier. The payee may provide the unique identifier to the payor by presenting his or her mobile electronic device to the payor's payment device (e.g., a point of sale system, another electronic device, a terminal, etc.), by emailing, texting, or otherwise communicating the payee's unique identifier, by speaking the payee's unique identifier, etc.

In one embodiment, the payor may communicate a payment instruction for the payment and the payee's unique identifier to the payor's financial institution.

In step 215, the payor's financial institution may associate the payment with the payee's unique identifier. In one embodiment, the payor's financial institution may provide a notification to the payee that the funds are available. In one embodiment, the payee may be provided with the locations of payment devices (e.g., ATMs, kiosks, or point of sale terminals) from where the payee may withdraw some or all of the funds.

In one embodiment, the payee may be provided with an internet link to access their pending payment. For example, if a notification is not provided, the payee may visit a website, enter personal details, and retrieve a payment. For example, an airline may provide a distressed passenger payment by instructing the passenger to go to a website, entering the passenger's name, and making arrangements to receive the payment.

In step 220, the payee may approach a payment device and may scan or otherwise receive a payment device identifier, such as a machine-readable code (e.g., a QR code), a NFC communication, etc., that may be associated with the payment device. The payment device identifier may be displayed by the screen, affixed to the payment device housing, etc.

The mobile payment application may optionally ask the payee for the amount or portion of their payment that the payee wishes to have the device dispense.

In step 225, the mobile payment application may communicate the payee's unique identifier and the payment device identifier to a backend for the financial institution, and, in step 230, the backend may then retrieve the funds that the payee has available.

In step 235, the backend may instruct the payment device to dispense the funds to the payee.

In one embodiment, the payee may keep any remaining funds (in the event they elect to have the device dispense a partial payment) in the mobile payment application, or may request delivery in a different method (e.g., have a check issued, transfer the funds to another account, etc.).

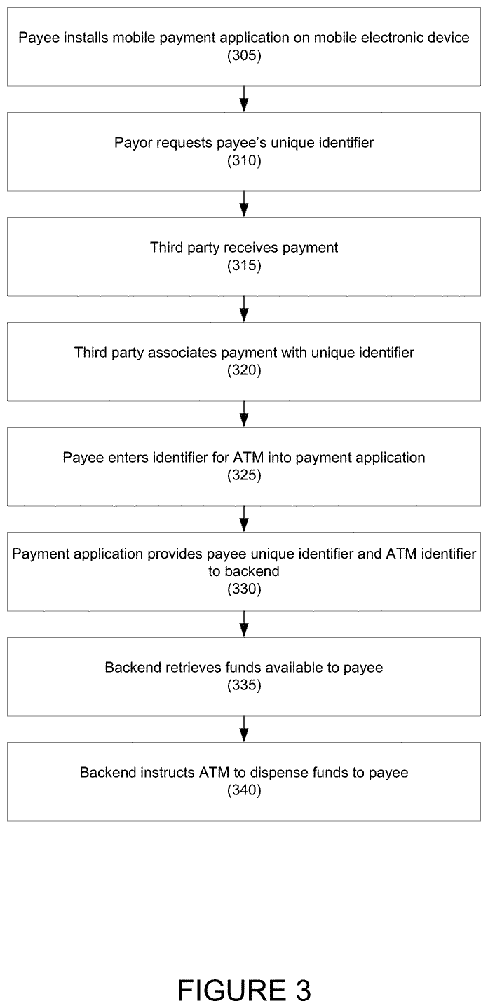

Referring to FIG. 3, a method for conducting accountless transactions using a third party is disclosed according to one embodiment.

In step 305, a payee may install a mobile payment application provided by a third party, such as a FinTech service provider, on a mobile electronic device. This is similar to step 205, above.

In one embodiment, the payor may communicate a payment instruction for the payment and the payee's unique identifier to the third party.

In step 310, a payor may request the payee's unique identifier. This may be similar to step 210, above.

In step 315, the third party may receive payment. In one embodiment, the third party may request funds from the payor's financial institution. In another embodiment, the third party may charge the payor's credit card, etc. Any suitable manner of receiving funds may be used as is necessary and/or desired.

In step 320, the third party may associate the payment with the payee's unique identifier, and may provide a notification to the payee that the funds are available.

In one embodiment, the payee may be provided with the locations of payment devices from where the payee may withdraw some or all of the funds, a link to access the payment, etc.

In step 325, the payee may approach a payment device and may scan or otherwise receive a payment device identifier, such as a machine-readable code (e.g., a QR code), a NFC communication, etc., that may be associated with the ATM, kiosk, or point of sale terminal. This may be similar to step 220, above.

In step 330, the mobile payment application may communicate the payee's unique identifier and the payment device identifier to a backend for the third party, and in step 335, the backend may then retrieve the funds that the payee has available.

In step 340, the backend may instruct the payment device to dispense the funds to the payee. This may be similar to step 235, above.

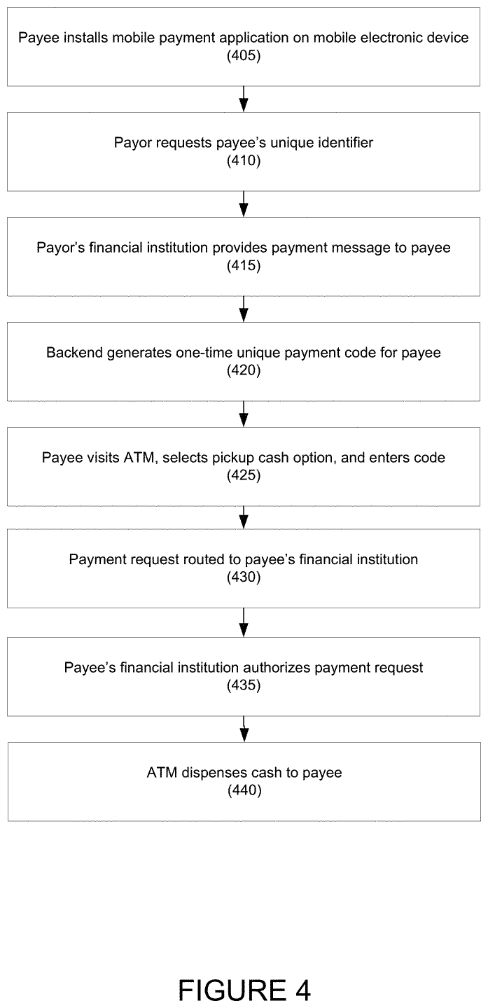

Referring to FIG. 4, a method for conducting accountless transactions is disclosed according to another embodiment. In step 405, a payee may install a mobile payment application provided the payee's financial institution on a mobile electronic device. The payee may also access this functionality via an internet browser on a mobile electronic device. The mobile payment application may generate a unique identifier for the payee as a machine-readable code, an alphanumeric string, etc. The unique identifier may also be the payee's mobile phone number, email address, etc.

In step 410, a payor may pay the payee by asking the payee for the payee's unique identifier. This may be similar to step 210, above.

In one embodiment, the payor may also register the payee to receive a payment via their service and the payee can access a website or other application to access the payment, for situations where the payee may not be sent a message to receive a payment, but a payment is still issued. The payee may be required to enter security information to positively identify the individual.

In one embodiment, the payor may communicate a payment instruction for the payment and the payee's unique identifier to the payor's financial institution.

In step 415, the payor's financial institution may provide a payment message to payee (via mobile, email, app, website, etc.) informing of availability of payment for pickup/disbursement. In one embodiment, a “pickup cash” option may be presented at a participating payment device (e.g., an ATM, kiosk, or point of sale terminal).

In one embodiment, if a payment message is not provided, the payee may visit a website, enter personal details, and retrieve a payment.

In step 420, when the payee selects the pickup cash option, the backend may generate and register a one-time payment code to the payee, such as a machine-readable code (e.g., a bar code such as a QR code, a NFC code, an alphanumeric string, etc.). In one embodiment the one-time payment code may be distributed via an interactive voice response system.

In one embodiment, the code may be formatted similar to an ATM/debit card account number.

In step 425, the payee may visit a participating payment device and may select the appropriate option (e.g., pickup cash), and may enter the one-time payment code. The code may be input into ISO-standardized ATM withdrawal messaging (originated by the payment device) to authenticate transaction back to original payment issuer, leveraging a participating network (e.g., an ATM network).

In step 430, the payment request may be routed to the payor's financial institution, and, in step 435, the payor's financial institution may authorize the request. In one embodiment, the authorization may serve as the payor's financial institution guarantee of payment.

In step 440, the payment device may dispense cash to the payee.

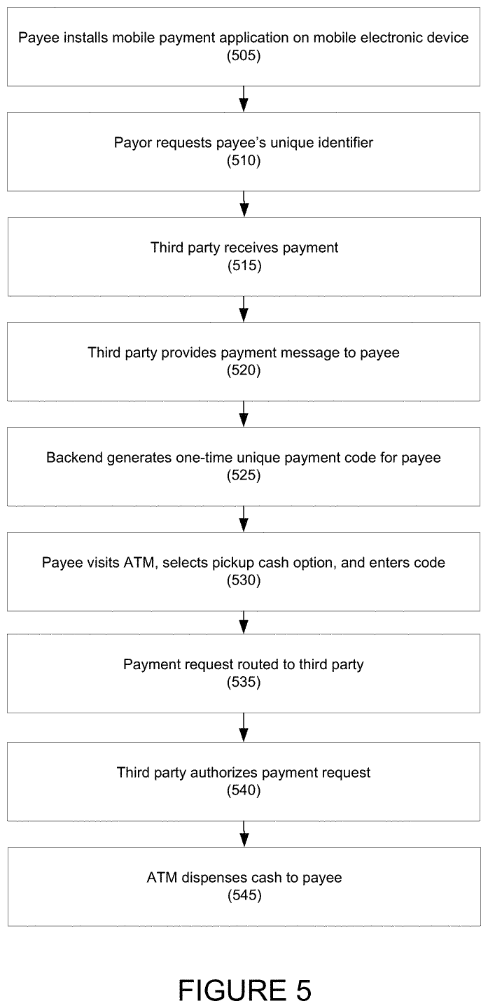

Referring to FIG. 5, a method for conducting accountless transactions is disclosed according to another embodiment. In step 505, a payee may install a mobile payment application provided by a third party, such as a FinTech service provider, on a mobile electronic device. This may be similar to step 405, above.

In step 510, a payor may pay the payee by asking the payee for the payee's unique identifier, and by using a feature to send money to the payee. This may be similar to step 410, above.

In one embodiment, the payor may communicate a payment instruction for the payment and the payee's unique identifier to the third party.

In step 515, the third party may receive payment. In one embodiment, the third party may request funds from the payor's financial institution. In another embodiment, the third party may charge the payor's credit card, etc. Any suitable manner of receiving funds may be used as is necessary and/or desired.

In step 520, the third party may provide a payment message to payee (via mobile, email, app, website, etc.) informing of availability of payment for pickup/disbursement. This may be similar to step 415, above.

In step 525, in response to the payment message, the payee selects the pickup cash option, and the backend may generate and register a one-time payment code to the payee. This may be similar to step 420, above.

In step 530, the payee may visit a participating payment device (e.g., an ATM, kiosk, or point of sale terminal) and may select the appropriate option (e.g., pickup cash), and may enter the one-time payment code. This may be similar step 425, above.

In step 535, the payment request may be routed to the third party, and, and, in step 540, the third party may authorize the request. In one embodiment, the authorization may serve as the payor's financial institution guarantee of payment.

In step 545, the payment device may dispense cash to the payee. This may be similar to step 440, above.

Thus, embodiments provide a non-customer of a financial institution or FinTech service provider to use a code to pick-up cash at a payment device without use of a traditional account token (card, NFC mobile, 3D barcode, etc.). For example, leveraging standardized ATM messaging may eliminate the need for specialized connectivity or the deployment of a new network.

In embodiments, a payee may receive a “payment available” message via SMS, email, voice messaging, etc. within moments after qualifying for payment. The payee then may view payment, select pickup cash, key in pickup amount, and visit the nearest participating A payment device to make a withdrawal, all without being a customer of any bank or having an ATM card.

In one embodiment, the payee may select full withdrawal or partial withdrawal. For example, if the payment amount cannot be fully dispensed owing to a payment device's stocked denominations or withdrawal limits, the balance may be transmitted to the payee via secondary method (e.g., ACH, gift card, prepaid card, etc.). Alternatively, the balance may remain associated with the payee for further withdrawal.

In one embodiment, the payee may enter a zip code, or provide the location of the mobile device using GPS in order to prevent fraud or payment code theft. The backend may verify that the location of the payment device and the mobile device match before authorizing funds to be dispensed.

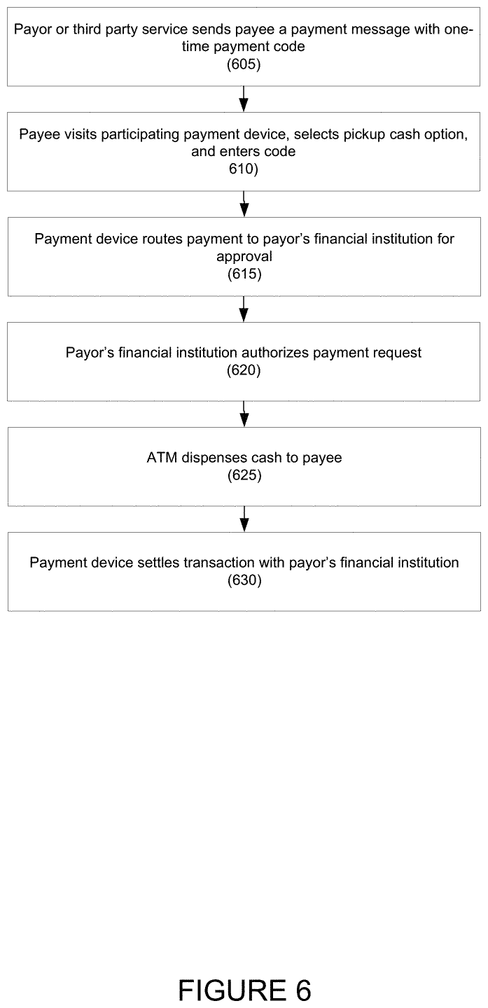

Referring to FIG. 6, a method for conducting accountless transactions is disclosed according to another embodiment.

In step 605, a payor, or a third-party service, may send a payee a payment message with a one-time payment code. In one embodiment, the payment advice notification may be communicated by email, SMS, etc.

In one embodiment, a payment application executed by the payor's electronic device may generate the payment message and the one-time payment code.

In one embodiment, the payment message may be communicated to a payment application executed by the payee's mobile electronic device.

In step 610, the payee may visit a participating payment device (e.g., an ATM, kiosk, or point of sale terminal) and may select the appropriate option (e.g., pickup cash), and may enter the one-time payment code. The code may be input into ISO-standardized ATM withdrawal messaging (originated by the ATM, kiosk, or point of sale terminal) to authenticate transaction back to original payment issuer, leveraging a participating network, (e.g., an ATM network).

In one embodiment, if the one-time payment code was received by the payment application, the payment application may present the one-time payment code for scanning by the payment device, may communicate the one-time payment code by NFC, etc.

In step 615, the payment may be routed to the payor's financial institution for approval and, in step 620, the payor's financial institution may authorize the request. In one embodiment, the authorization may serve as the payor's financial institution guarantee of payment.

In step 625, the payment device may dispense cash to the payee.

In step 630, the payment device terminal may settle the transaction with the payor's financial institution.

Although several embodiments have been disclosed, it should be recognized that these embodiments are not exclusive to each other, and certain elements or features from one embodiment may be used with another.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for conducting accountless transactions, comprising:
in an information processing apparatus comprising at least one computer processor:
receiving, from a payor, a payee unique identifier and a payment instruction comprising a payment amount;
associating the payment instruction with the payee unique identifier;
receiving, from a mobile payment application executed by a mobile electronic device, a payment device identifier for a payment device and the payee unique identifier;
retrieving the payment instruction associated with the payee unique identifier;
identifying the payment device based on the payment device identifier; and
instructing the identified payment device to dispense at least some of the payment amount.

2. The method of claim 1, wherein the payee unique identifier is provided by the mobile payment application.

3. The method of claim 1, further comprising notifying the payee of a plurality of payment devices for receiving the payment.

4. The method of claim 1, wherein the payment device comprises at least one of an ATM, a kiosk, and a point of sale terminal.

5. The method of claim 1, wherein the payment device identifier comprises a machine-readable code or a secure token.

6. The method of claim 1, wherein the information processing apparatus is provided by a financial institution with which the payor has an account.

7. The method of claim 1, wherein the information processing apparatus is provided by a third party, and further comprising:
receiving the payment amount from the payor; and
providing the payment amount to an owner of the identified payment device.

8. A method for conducting accountless transactions, comprising:
in an information processing apparatus comprising at least one computer processor:
receiving, from a payor, a payee unique identifier and a payment instruction comprising a payment amount;
generating a one-time code for the payee;
associating the one-time code with the payment instruction;
providing a payment message to the payee comprising the one-time code;
receiving, from a payment device, a payment request comprising the one-time code; and
instructing the payment device to dispense at least some of the payment amount.

9. The method of claim 8, wherein the payee unique identifier comprises a payee phone number or a payee email address, and the payment message is communicated to the payee phone number or the payee email address.

10. The method of claim 8, further comprising:
routing the payment request to a financial institution associated with the payee; and
receiving approval for the payment request from the payee's financial institution.

11. The method of claim 8, wherein the payment device comprises at least one of an ATM, a kiosk, and a point of sale terminal.

12. The method of claim 8, wherein the one-time code comprises a machine-readable code or a secure token.

13. The method of claim 8, wherein the one-time code comprises a 16-digit code.

14. The method of claim 1, wherein the information processing apparatus is provided by a financial institution with which the payor has an account.

15. The method of claim 8, wherein the information processing apparatus is provided by a third party, and further comprising:
receiving the payment amount from the payor; and
providing the payment amount to an owner of the identified payment device.

16. A method for conducting accountless transactions, comprising:
in an information processing apparatus comprising at least one computer processor:
receiving, from a payor, a one-time payment code and a payment instruction comprising a payment amount;
receiving, from a payment device, a payment request comprising the one-time payment code;
retrieving the payment instruction associated with the one-time payment code; and
communicating authorization of the payment request to the payment device, whereby the payment device dispenses at least some of the payment amount.

17. The method of claim 16, further comprising:
settling the payment amount with a provider of the payment device.

18. The method of claim 16, wherein the one-time code payment comprises a 16-digit code.

19. The method of claim 16, wherein the one-time payment code is communicated to a payment application executed by a payee mobile electronic device, and the payee mobile electronic device provides the one-time payment code to the payment device.

20. The method of claim 16, wherein the payment device comprises an ATM, a kiosk, or a point of sale terminal.
